(19) United States
(12) Patent Application Publication
(10) Pub. No.: US 2002/0122690 A1
(43) Pub. Date: Sep. 5, 2002

(54) Spring energized connector

(76) Inventors: Daniel Poon, Westminster, CA (US); Peter J. Balsells, Newport Beach, CA (US)

Correspondence Address: WALTER A. HACKLER, Ph.D., Suite B, 2372 S.E. Bristol, Newport Beach, CA, 92660-0755, US

(21) Appl. No.: 10/090,325

(22) Filed: Mar. 4, 2002

Related U.S. Application Data
(60) Provisional application No. 60/273,427, filed on Mar. 5, 2001.

(51) Int. Cl. F16D 1/00

(52) U.S. Cl. 403/326

(57) ABSTRACT

A spring energized connector includes an axial spring ring disposed within a housing having a bore with an internal groove for retaining the spring. A piston is provided having an external groove for receiving a portion of this spring and a chamfer is provided for radially expanding the spring as the piston is inserted into the bore in a connect direction with a selected connect force. A contact retaining wall, defining an internal groove sidewall, is disposed at an angle from a normal to a bore centerline for causing axial compression of the spring as the piston is moved in a disconnect direction, opposite the connect direction, causing a disconnect force, in the disconnect direction, greater than a connected force.

The present invention generally relates to connectors and is more particularly directed to releasable joining members of various shapes.

In many applications in electrical, safety and medical devices it is necessary to assemble two parts using a very light force but which require a very high force to disconnect the parts. The reverse force relatively may also find application. That is, a very high force may be required to connect two parts and very little force to disconnect the parts. With regard to electrical connectors the connected parts must also exhibit electrical conductivity therethrough when connected.

Heretofore, quick connected couplings between cylindrical members utilized a multitude of components in order to provide temporary locking of the members together.

Locking mechanisms have been developed, see for example, U.S. Pat. Nos. 4,678,210, 5,082,390, 5,411,348, and 5,545,842 to Balsells, however none of these devices provide for two generally cylindrical surfaces which can be assembled, requiring little force to connect and high force to disconnect with tailored connect to disconnect force ratios.

The present invention provides for a circular canted coil spring assembled in a housing groove and a shaft with a groove in which the spring is positioned in a manner such that when the shaft is moved axially against the housing the spring is compressed axially against the groove, creating an axial force. This force increases until the radial component exceeds the sum of its own static frictional component and the spring expanding force at which point separation may occur.

### SUMMARY OF INVENTION

A spring energized connector in accordance with the present invention generally includes an axial spring ring comprising a plurality of interconnected elliptical coils. The spring ring includes an inside and an outside diameter with a centerline therebetween and each coil has a height and a width measured, respectively, along a minor axis and a major axis of each coil.

A housing is provided which includes a bore with an internal groove for retaining the spring. The housing a groove has a depth which is greater than the coil width and the spring inside diameter is smaller than a diameter of the bore.

A piston is provided having an external groove for receiving a portion of the spring and a chamfer for radially expanding the spring as the piston is inserted into the bore in a connect direction with a selected connection force.

A contact retaining wall defines a housing internal groove sidewall and is disposed at an angle from a normal to the bore center line for causing axial compression of the spring as the piston is moved in a disconnect direction, which is opposite the connect direction, and results in a disconnect force which is greater than the connect force.

The contact angle may be between about 0° and about 30°, and preferably about 15°, which results in a ratio of disconnect to connect force greater than 1 and greater than about 20. This is enabled when a point of loading of the spring by the plunger during disconnect is inside the spring ring centerline.

In one embodiment, a second retaining wall is provided which defines a second internal groove sidewall disposed angle from the normal with the two retaining walls defining a tapered groove. This structure includes the advantage of forcing the spring to an original position after compression during disconnect.

In another embodiment of the present invention an internal groove bottom is disposed at an angle to the piston centerline this causes a radial compression of the coils which develops added force.

In yet another embodiment of the present invention the groove may be formed by adjacent housing members in order to facilitate manufacture.

An still another embodiment of the present invention a second spring may be provided and disposed within the axial spring ring along an inside diameter for urging the spring ring to an original position within the housing after disconnect.

A further embodiment of the present invention includes a contact retaining wall which defines a piston external groove side wall which is disposed at an angle from a normal to a bore center line for causing axial compression of the spring as the piston is moved in a disconnect direction, opposite the connect direction, which further produces a disconnect force greater than a connect force.

An still another embodiment of the present invention a spring energized connector includes an axial spring ring comprising a plurality of interconnected elliptical coils with the ring having an inside and outside diameter with a center line therebetween. Each coil includes a height and the width measured respectively along a minor axis and a major axis of each coil.

A piston is provided which includes external groove for retaining the spring. The piston groove has a depth greater than the coil width and the spring inside diameter is larger than a diameter of the piston. A housing is provided which includes a bore with an internal groove for receiving a portion of the spring.

A contact retaining wall defines a piston external groove sidewall and is disposed at an angle from a normal to the piston centerline for causing axial compression of the spring as the piston is moved in a disconnect direction, the disconnect direction being opposite the connect direction and a disconnect force is greater than the connect force.

A method in accordance with the present invention for controlling relative connect and disconnect forces in a spring energized connector includes providing a contact retaining wall for defining an internal groove sidewall and disposing the retaining wall at an angle from a normal to a bore centerline for causing axial compression of the spring as a piston is moved in a disconnect direction.

The connector itself includes an axial spring ring comprising a plurality of interconnected elliptical coils with the ring having an inside and an outside diameter with a centerline therebetween. Each coil includes height and the width measured, respectively along a minor axis and a major axis of each coil.

A housing suitable for the method of the present invention includes a bore and an internal groove for retaining the spring with the housing groove having a depth greater than the coil width. The spring inside diameter is smaller than diameter of the bore.

A piston suitable for practicing the method of the present invention includes an external groove for receiving a portion of the spring and a chamfer for radially expanding the spring as the piston is inserted into the bore in a first direction with a selected connect force.

### BRIEF DESCRIPTION OF THE DRAWINGS

The advantages that teaches of the present invention would be better understood by the following description when considered in conjunction with the accompanying drawings in which:

FIG. 1 is a cross sectional view of one embodiment in accordance with the present invention generally showing a housing, with an internal groove, a spring, and a piston with an external groove shown in separate positions before connection therebetween;

FIG. 2 is a cross sectional view similar to that shown in FIG. 1 illustrating assembly of the piston into a housing bore;

FIG. 3 is a cross sectional view similar to that shown in FIG. 1 illustrating assembly of the piston into the housing at a point where maximum insertion force occurs;

FIG. 4 is a cross sectional view similar to that shown in FIG. 1 with the piston and housing are fully connected;

FIG. 5 is a plot of insertion force as a function of travel of the piston in an engagement direction as shown in FIGS. 1-4;

FIG. 6 is a cross sectional view similar to FIG. 1 showing the first step(s) of disconnecting the piston from the housing;

FIG. 7 is a cross sectional view of the connector shown in FIG. 6 illustrating a point of disconnect and wherein the spring ring begins to expand radially;

FIG. 8 is a cross sectional view similar to that shown in FIG. 7 with the spring diameter expanding allowing for separation;

FIG. 9 is a cross section view similar to that shown in FIGS. 1 and 8 showing the piston disconnected from the housing;

FIG. 10 is a plot of the force necessary for disconnection of the piston from the housing as a function of travel which should be compared to FIG. 5;

FIG. 10 is a cross sectional view of an alternative embodiment of the present invention similar to that shown in FIG. 1 in which the piston includes a retaining wall for controlled compression of the spring ring;

FIG. 11 is a cross sectional view of another embodiment of the present invention in which the spring ring is disposed in the piston and a housing includes a contact retaining wall for causing axial compression of the spring as the piston is moved in a disconnect direction;

FIG. 12 is a cross sectional view of yet another embodiment of the present invention in which a housing includes two contact retaining walls defining a tapered groove therein;

FIG. 14 shows a cross sectional view of still another embodiment of the present invention in which the housing groove includes a bottom disposed at an angle to centerline and the piston includes a groove with a contact retaining wall disposed at a normal to the more center lines;

FIG. 15 is a cross sectional view of another embodiment of the present invention similar to FIG. 14 with the piston groove has rectalinear sides;

FIG. 16 is a cross sectional view of yet another embodiment of the present invention in which the piston includes two contact retaining walls defining a tapered groove;

FIG. 17 is a cross sectional view of another embodiment of the present invention in which the groove is defined by two housing members;

FIG. 18 is yet another embodiment of the present invention in which the housing groove includes a bevel, or chafer with two angles for facilitating entry of the spring into the housing groove;

FIG. 19 is yet another embodiment of the present invention generally showing a second spring disposed within the axial spring along an inside diameter for urging the spring ring to an original position within the housing bore after disconnectment; and

FIG. 20 is yet another embodiment of the present invention in which a contact retaining in the housing groove is disposed at an angle opposite to that shown in FIG. 1 which results in a groove width which is progressively wider in a direction away from the piston.

### DETAILED DESCRIPTION

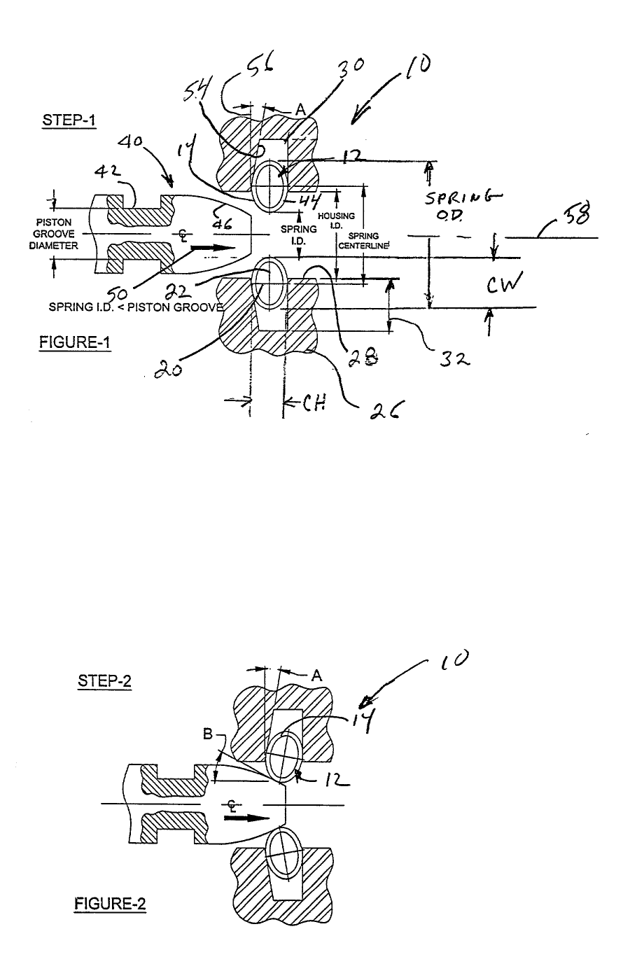

With reference to FIGS. 1-4 there is shown a spring energized connector 10 generally including an axial spring ring 12 which includes a plurality of interconnected elliptical coils 14. Suitable spring rings for use in the present invention are described in U.S. Pat. No. 5,108,078 and 5,139,243 to Balsells and art to be incorporated herewith in their entirety by this specific reference thereto for describing the spring ring 12 with coils 14.

As shown in FIG. 1 the spring 12 includes a spring inside diameter I.D., a spring outside diameter O.D. and a spring centerline I.D. all identified in FIG. 1. Also as identified in FIG. 1 each coil 14 has a height CH measured along a minor axis 20 and a coil width CW measured along a major axis 22.

The connector 10 also includes a housing 26 having a bore 28 with an internal groove 30 for retaining the spring 12. As shown in FIG. 1 the groove 30 has a depth 32 which is greater than the coil, width CW and the spring inside diameter I.D. is smaller than a diameter of the bore 28.

The connector 10 includes a piston 40 having an external groove 42 for receiving a portion 44 of the spring 12 and a chamfer 46 for radially expanding the spring 12 as the piston 40 is inserted into the bore 28 in a connect direction indicated by the arrow 50 with a select connect force which is typically minimal as hereinafter described.

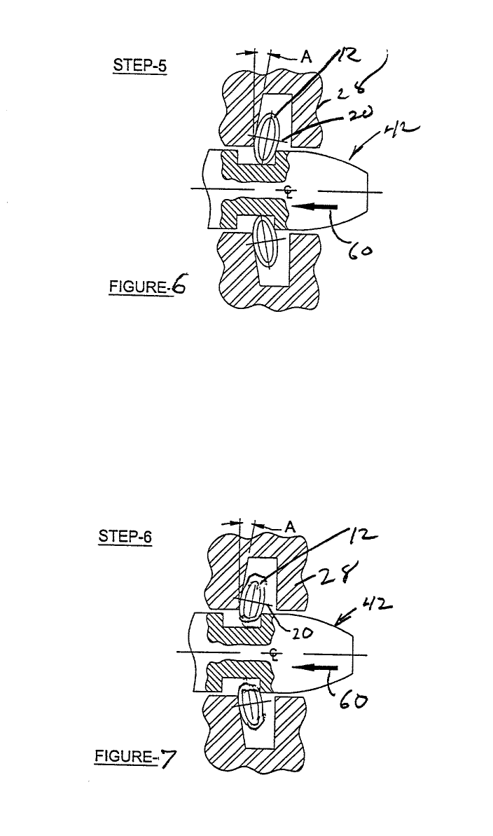

A contact retaining wall 54 is provided and disposed as an internal groove 30 sidewall which is disposed at an angle A from a normal 56 to a bore centerline 58. The contact retaining wall when disposed at an angle A of about 0° and about 30° causes axial compression of the spring 12 as the piston 40 is moved in a disconnect direction as indicated by the arrow 60 in FIGS. 6-9 as hereinafter described in greater detail. Importantly the disconnect force is greater, and preferably substantially greater, than the connect force as hereinafter described.

FIGS. 1-4 illustrate the step(s), or sequence, of the connecting forces for connecting the housing 26 and the piston 40 by way of the spring 12, character references for individual structural features set forth in FIG. 1 being omitted in FIGS. 2-4 for the sake of clarity in presenting the sequence of connecting step(s).

FIG. 1 represents step(s) 1 in which the axial spring ring 12 is placed into the housing 26 and is centered radially. Generally, the housing groove width at the inside diameter of the housing 28 can be smaller, equal, or larger than the spring coil height CH and the housing groove depth is greater than the spring width, or in other words, the housing groove diameter is greater than the sum of the housing I.D. and twice the spring coil width CW.

The spring I.D. is generally less but can be equal to, or, greater than the piston groove diameter, although smaller than the piston groove is preferable. The diameter of the spring ring coil centerline can be smaller, equal or larger than the housing I.D. The chamfer 46 on the piston 40 preferably is long in order to gradually expand the spring ring 12 upon connection. In step(s) 1, before insertion, no force is applied on the piston as is shown in FIG. 5.

With the reference to FIG. 2, step(s) 2 of connection is shown with the piston 40 inserted through the inside diameter of the axial spring ring 12 causing it to expand radially and the coils 14 to compress axially the force required to past the piston 40 through the I.D. of the spring 12 is dependant upon the radial force required to expand the spring ring 12, the contact retaining angle A and the contact angle B (see FIG. 2), the force necessary to compress the spring 12 axially and the coefficient of friction among the components. This force is also represented in FIG. 5 as indicated for step(s) 2.

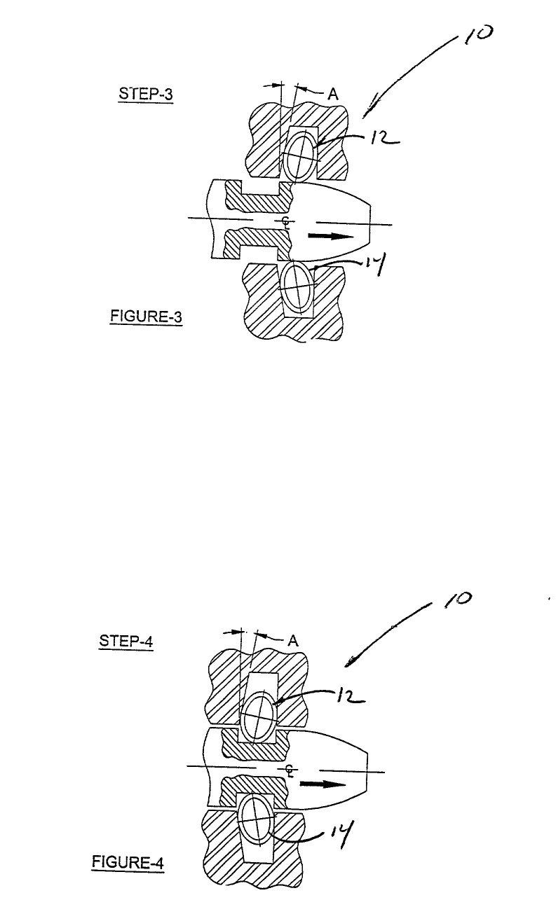

FIG. 3 illustrates step(s) 3 of the connection in which maximum insertion force occurs. This maximum force occurs when the piston O.D. contacts the expanded axial spring I.D. and is represented in FIG. 5 as step(s) 3.

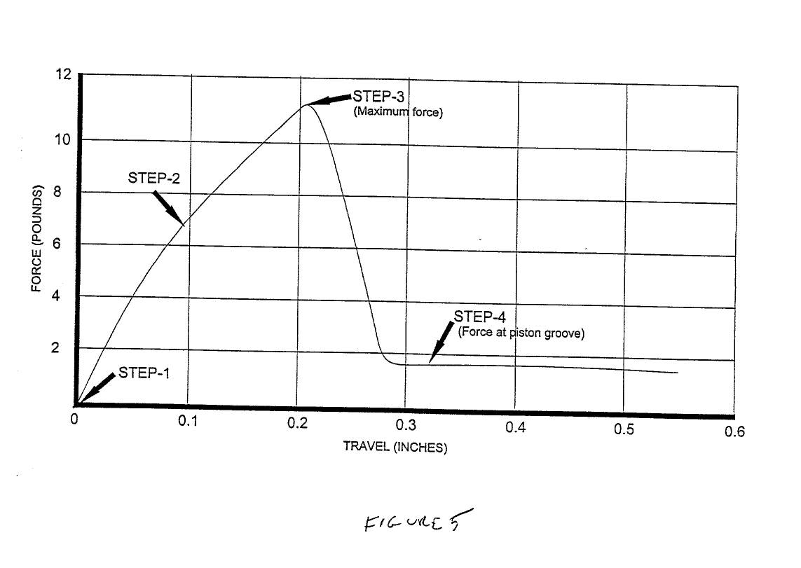

FIG. 4 illustrates step(s) 4 in which the piston 40 and housing 28 are connected the spring I.D. connects the piston groove 42 diameter. When electrical current must pass from the housing 22 to the piston 40 or vice versa, sufficient radial force must be applied at the I.D. of the spring ring 12 and the piston groove 42 to insure sufficient conductivity. A greater angle A will provide a greater radial force to insure this contact. Thus the contact retaining wall 54 further functions to control conductivity between the piston 40 and the housing 28. This force is shown in step(s) 4 in FIG. 5.

The disconnect step(s) and sequence forces are shown in FIGS. 6-10. In step(s) 5 as the piston 42 is moved in the disconnect direction 60 the spring coils 14 are compressed axially on the minor axis 20. A slight rotation of the spring ring 12 elliptical cross section occurs due to misalignment of the forces acting on the spring 12 from the piston 42 and the housing 28.

The removal force at this time is approximately equal to the axial spring ring 12 canted compression force. Increasing the force will cause the spring ring 12 to expand radially. As the coils 14 are compressed axially there is an increase in the force required to expand the spring ring 12 as the coils 14 become more rigid. The force required is illustrated in the FIG. 10 indicated by step(s) 5.

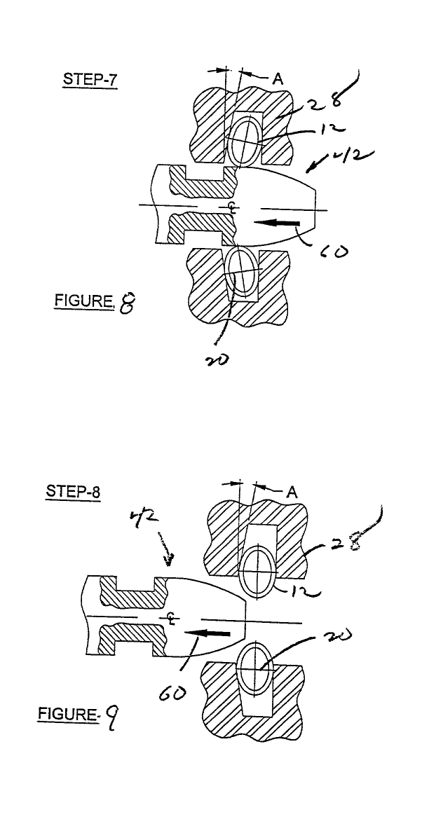

In step(s) 6, as shown in FIG. 7, moving the piston 42 axially against the spring 12 compresses the spring coils 14 axially allowing the spring 12 to expand radially. A slight rotation of the spring 12 elliptical cross section occurs during such compression. The contact retaining angle A of 15° is preferable and has been found to work satisfactorily for most applications. Variations of the angle A will vary the disconnect force desired. Generally the lower the angle A the lower the axial disconnect force developed. Also, the angle A facilitates release of the spring ring from the housing. That is the disconnect force increases until the radial component exceeds the spring ring expansion of force. These forces are illustrated in FIG. 10.

In step(s) 7 as shown in FIG. 8 the spring I.D. contacts the piston diameter and the spring coils 14 are contained within the housing groove 30. The spring coils 14 are compressed axially and the spring 12 is contracted radially bearing on the piston O.D. the continued radial removal force is the result of the radial spring ring 12 force acting on the piston O.D. multiplied by the dynamic coefficient of friction.

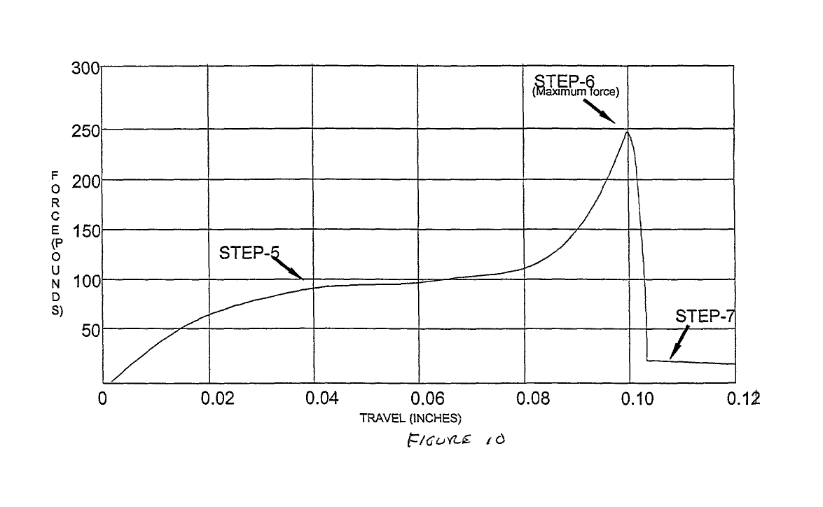

In step(s) 8, as illustrated in FIG. 9, the piston 42 is removed and the spring 12 remains in the housing groove 30 as it was in the initial condition, shown in FIG. 1.

Relative connect-disconnect forces can be appreciated by comparing FIG. 5 with FIG. 10. As shown with an angle A of 15° a ratio of approximately 248/11=22.5 occurs. This is a typical example of connect-disconnect force ratios which are also affected by various parameters such as spring design, groove design, material of components, coefficient of friction among others.

Material of construction plays a part in the resulting ratio of connect and disconnect forces inasmuch as the coefficient of friction is different for a material such as plastic compared to metals.

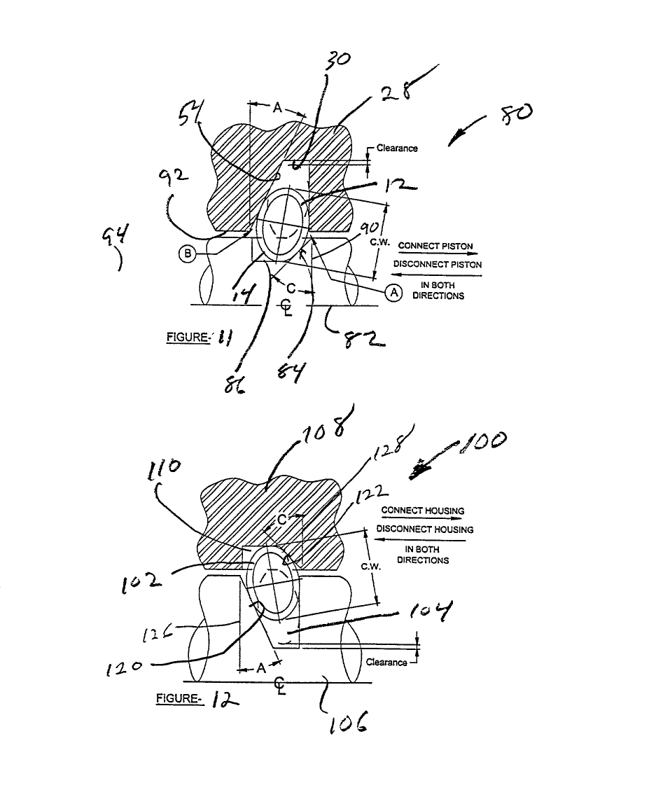

FIG. 11 shows an alternative embodiment 80 of a connector in accordance with the present invention with common reference numbers indicating identical or substantial similar parts hereinbefore discussed in connection with embodiment 10.

The embodiment 80 utilizes a piston 82 having a contact retaining wall 84 defining an external groove 86 sidewall which is disposed at an angle C from a normal 90 to a bore 92 centerline 94, dashed lines in the Figures indicate the position of the coils 14 at the highest radial expansion of the spring 12.

The highest point of loading of the piston 82 must contact the coil 14 at or below the centerline of the coil height at point A while another portion of the coil centerline must be above the point B when the spring 12 is housed in the groove 30 with the angular wall 54.

Incorporation of the wall 84 at an angle C facilitates disassembly. To assure disconnect features it is very important at the point of loading of the coil 14 is at the centerline of the coil 14 or below. If the contact point is above the centerline disconnection may not be possible, The lower the contact point, the lower the force required to compress and turn the spring coils 14 and lower the disconnect force.

As illustrated in FIG. 11 disconnect can be done in either direction for this embodiment 80. Greater force is developed when the disconnect force is against the angle A than when the disconnect force is against the non angular wall of the housing groove.

With reference to FIG. 12 there is shown an alternative embodiment 100 of the present invention in which a ring spring 102 is disposed in a groove 104 of a piston 106 and connected to a housing 108 by way of a housing groove 110. Contact walls 120 of the groove 104 and 122 of the groove 110 disposed at angles A and C respectively to a normals 126, 128 provide the featured connect, disconnect forces as hereinabove discussed.

FIG. 13 is yet another embodiment 150 with a housing 152 having a groove 154 with two (2) angled sidewalls 156, 158 producing a tapered groove 154. This feature is desirable in that it always forces the spring ring 160 to its original position after compression while connecting the piston 162 to the housing 152. Incorporation of angled surfaces 164, 166 at angles C to normals 170, 172 facilitates disassembly of the piston 162 from the housing 152.

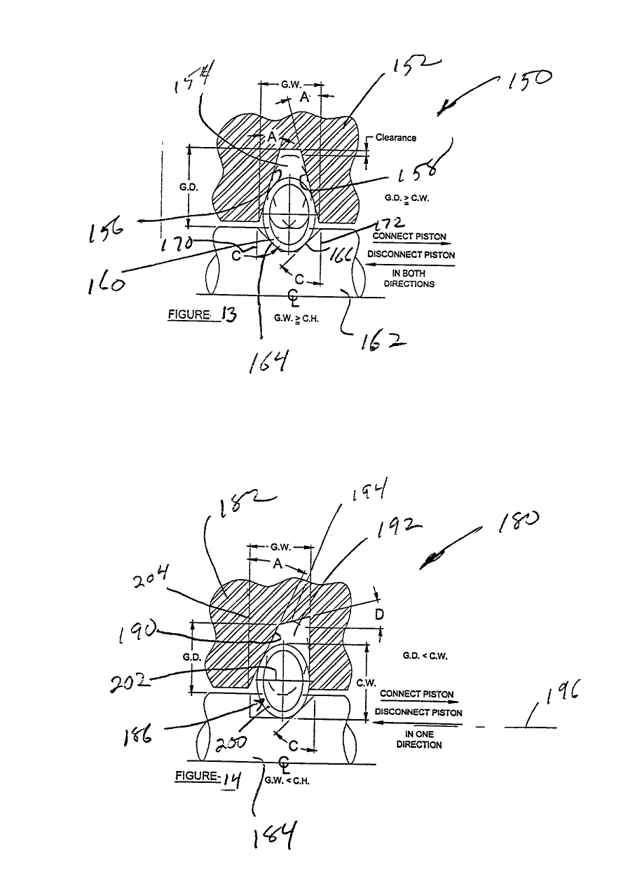

FIG. 14 shows yet another embodiment 180 of the present invention including a housing 182 piston 184 and ring 186. In addition to the angled wall 190 the groove 192, a groove bottom 194 is provided which is disposed at an angle B to a piston centerline 196. In this embodiment upon moving the spring 186 against the bottom 194 of the groove 192 there will be a radial compression of the spring 186 on an outside diameter of the spring 186 which develops added force and causes the spring 186 to turn and compress spring coils 200 along the minor axis 202. The surface 190 at an angle A to a normal 204 facilitates compression of the coil during disconnect as hereinabove described.

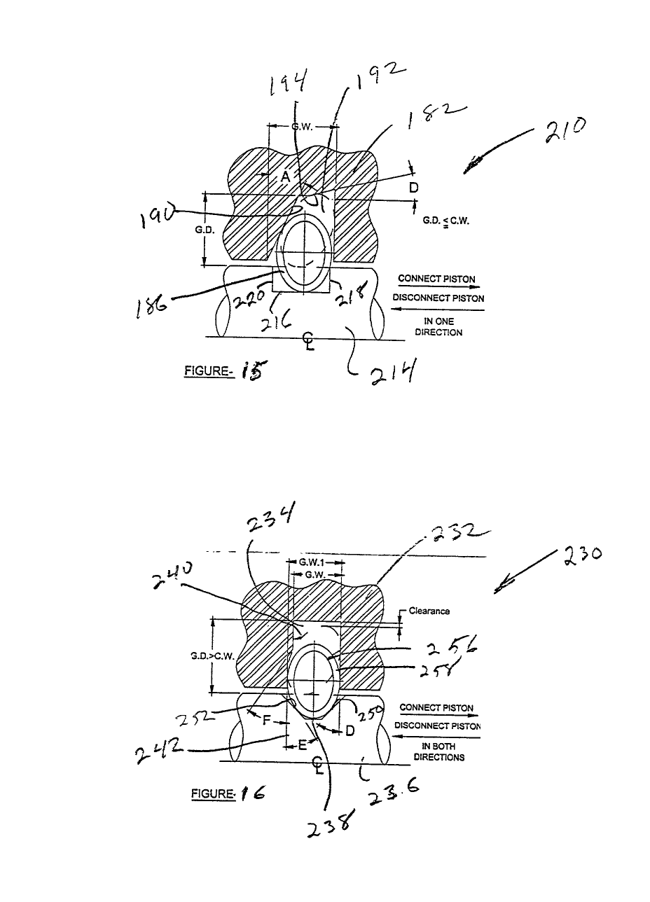

Another embodiment, or variation, 210 is illustrated in FIG. 15 which is similar to the embodiment 180 shown in FIG. 14 and in which common reference numbers represent equivalent structural features hereinabove discussed in connection with FIG. 14.

In the embodiment 210 the piston 214 includes a groove 216 with rectalinear sidewalls 218, 220. As hereinabove described the flat surface, of wall 190 allows high compression of the spring 186 and after it reaches a certain specific force, controlled by a diameter a groove 192, it allows the spring 186 to turn and slide to one side and decrease the spring force at that point. In this manner disconnect forces can be further tailored to suit a specific application.

With reference to FIG. 16 and there is shown yet another embodiment 230 having a housing 232 with groove 234 and piston 236 with groove 238 a groove wall 240 at an angle F to a normal 242 facilitates transition forces from the groove width GW 12 GW as shown in FIG. 16.

The piston groove 238 includes a sidewall 250 disposed at an angle D and a sidewall 252 disposed at an angle E which is incorporated for facilitating connection. In addition, the housing groove I.D. has been made slightly wider at the I.D. of the groove 234 to increase initial force during separation by allowing the spring 256 to be compressed near the centerline of the coil 258. The groove width GW., can be small, equal to, or larger than the coil height at the larger end diameter of the groove; and at the smaller diameter of the groove, the groove width GW. can be smaller, equal to, or larger than the coil height Such variations permit a wide range of forces and disconnect and connect.

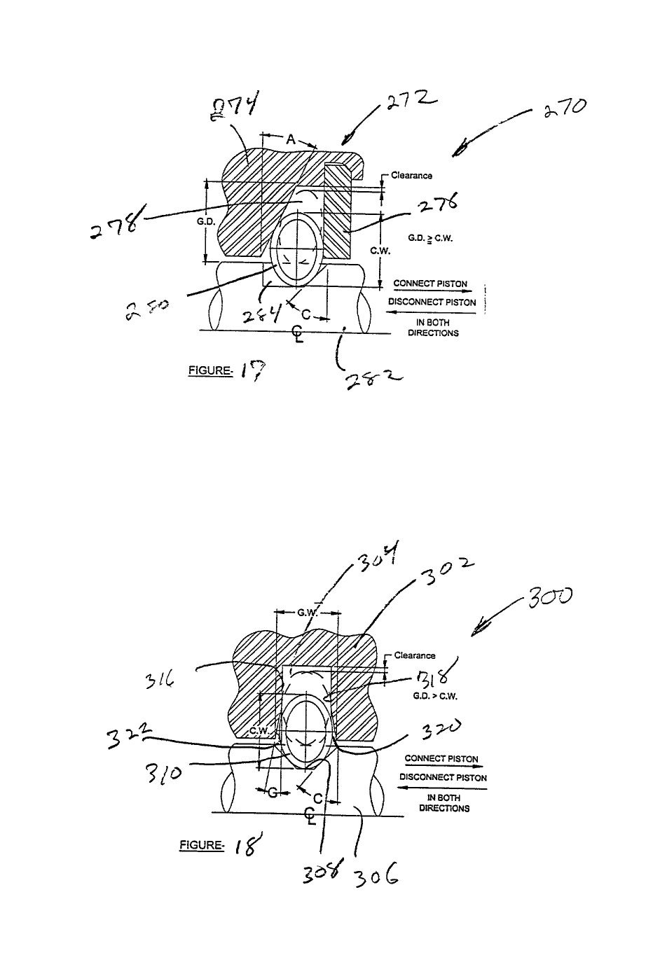

Still another embodiment 270 is shown in FIG. 17 in which a housing 272 consists of two members 274, 276 defining a groove 278 along with a spring 280 for interconnecting with a piston 282 having a groove 284. In this embodiment the two housing members 274, 276 are utilized to facilitate its manufacture in very small diameters when fabricating a single one-piece groove is extremely difficult to make.

Yet another embodiment 300 is shown in FIG. 18 which includes a single piece housing 302 with a groove 304 a piston 306 with groove 308 and interconnecting spring 310. In this instance the groove 304 has sidewalls 316, 318 with a flared opening 320 with entry angles G to facilitate entry of the spring 310 into the groove 304. The groove can be small, equal to, or larger than the coil height and the length of the chamfer 22 can be vary depending on particular requirements for the connect/disconnect forces.

With reference to FIG. 19 there is shown another embodiment 350 utilizing housing 352 with groove 354 piston 356 with groove 358 and a spring 360. In this embodiment 350 a circular garter, or circular wire, spring 366 is disposed within the ring spring 360 along an inside diameter 368 of the spring 360 which assists in returning the spring 360 to its original position following compression.

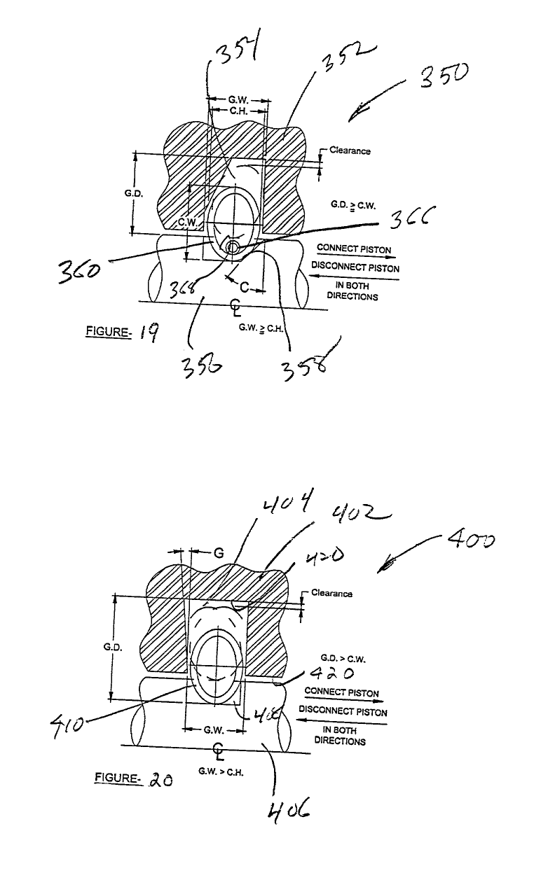

With reference to FIG. 20 there is shown another embodiment 400 having a housing 402 with groove 404 piston 406 with groove 408 and spring 410. In this embodiment of 400 the groove 404 width at the bore surface 420 is narrower than the groove width at a bottom 422 of the groove 404. Thus, the groove 404 widens which is illustrated by the angle G in FIG. 20 this structure limits the retaining frictional force and retains the spring in place at initial assembly.

Although there has been described hereinabove a specific spring energized connector according to the present invention for the purpose of illustrating the manner which the invention may be used to advantage, it should be appreciated that the invention is not limited thereto. Accordingly, any and all modifications, variations, or equivalent arrangement which may occur to those skilled in the art are to be considered within the scope of the invention as defined in the appended claim.

What is claimed is:

1. A spring energized connector comprising:
an axial spring ring comprising a plurality of interconnected elliptical coils, the ring having an inside and an outside diameter with a centerline therebetween, each coil having a height and a width measured, respectively, along a minor axis and a major axis of each coil;
a housing having a bore with an internal groove for retaining the spring, the housing groove having a depth greater than the coil width, the spring inside diameter being smaller than a diameter of said bore;
a piston having an external groove for receiving a portion of the spring and a chamfer for radially expanding the spring as the piston is inserted into the bore in a connect direction with a selected connect force;
a contact retaining wall defining an internal groove sidewall is disposed at an angle from a normal to a bore centerline for causing axial compression of the spring as the piston is moved in a disconnect direction, opposite said connect direction, and a disconnect force, in said disconnect direction, greater than the connect force.

2. The connector according to claim 1 wherein the contact retaining wall angle is between 0° and about 30° and a ratio of disconnect force to connect force is greater than 1 to greater than 20.

3. The connector according to claim 1 wherein the contact retaining wall angle is about 15° and a ratio of disconnect force to connect force is greater than 20.

4. The connector according to claim 1 wherein a point of loading the spring by the piston during disconnect is inside the spring ring centerline.

5. The connector according to claim 1 further comprising a second retaining wall defining a second internal groove sidewall disposed at an angle from the normal, the two retaining wall defining a tapered groove for forcing the spring to an original position after compression during disconnect.

6. The connector according to claim 1 wherein an internal groove bottom is disposed at an angle to the piston centerline.

7. The connector according to claim 1 wherein the housing internal groove is defined by adjacent housing members.

8. The connector according to claim 1 further comprising a second spring disposed within the axial spring ring along an inside diameter for urging the spring ring to an original position within the housing internal bore after disconnect.

9. A spring energized connector comprising:
a axial spring ring comprising a plurality of interconnected elliptical coils, the ring having an inside and an outside diameter with a centerline therebetween, each coil having a height and a width measured, respectively, along a minor axis and a major axis of each coil;
a housing having a bore with an internal groove for retaining the spring, the housing groove having a depth greater than the coil width, the spring inside diameter being smaller than a diameter of said bore;
a piston having an external groove for receiving a portion of the spring and a chamfer for radially expanding the spring on the piston is inserted into the bore in a connect direction with a selected connect force;
a contact retaining wall defining an external groove sidewall, disposed at an angle from a normal to a bore centerline for causing axial compression of the spring on the piston is moved in a disconnect direction, opposite said connect direction, and a disconnect force, in said disconnect direction, greater than the connect force.

10. The connector according to claim 9 wherein the housing internal groove has a flared opening.

11. The connector according to claim 9 wherein the contact retaining wall angle is between 1° and 30° and a ratio of disconnect force to connect force is greater than 1 to greater than about 20.

12. The connector according to claim 9 wherein the contact retaining wall angle is about 15° and a ratio of disconnect force to connect force is than about 20.

13. The connector according to claim 9 wherein a point loading the spring by the piston during disconnect is inside the spring ring centerline.

14. The connector according to claim 9 further comprising a second retaining wall defining a second external groove sidewall disposed at an angle from the normal, the two retaining wall defining a tapered groove for forcing the spring to an original position after compression during disconnect.

15. The connector according to claim 9 further comprising a second spring is disposed within the axial spring ring along the inside diameter for urging the spring ring to an original position within the housing internal bore after disconnect.

16. A spring energized connector comprising:
an axial spring ring comprising a plurality of interconnected elliptical coils, the ring having an inside and an outside diameter with a centerline therebetween, each coil having a height and a width measured, respectively, along a minor axis and a major axis of each coil;
a piston having a external groove for retaining the spring, the piston groove having a depth greater than the coil width, the spring inside diameter being larger than a diameter of said piston;
a housing having a bore with an internal groove for receiving a portion of the spring;
a contact retaining wall defining an external groove sidewall disposed at an angle from a normal to a piston centerline for causing axial compression of the spring on the piston is moved in a disconnect direction, opposite said connect direction, and a disconnect force in said disconnect direction greater than the connect force.

17. The connector according to claim 16 wherein the contact retaining wall angle is between 1° and 30° and a ratio of disconnect force to connect force is greater than about 1 to greater than about 20.

18. The connector according to claim 16 wherein the contact retaining wall angle is about 15° and a ratio of disconnect force to connect force is greater than about 20.

19. The connector according to claim 16 wherein a point loading the spring by the plunger during disconnect is inside the spring ring centerline.

20. A method for controlling relative connect and disconnect forces in a spring energized connector the connector comprising:
an axial spring ring comprising a plurality of interconnected elliptical coils, the ring having an inside and an outside diameter with a centerline therebetween, each coil having a height and a width measured, respectively along a minor axis and a major axis of each coil;
a housing having a bore with an internal groove for retaining the spring, the housing groove having a depth greater than the coil width, the spring inside diameter being smaller than a diameter of said bore; and
a piston having an external groove for receiving a portion of the spring and a chamber for radically expanding the spring as the piston is inserted into the bore in a connect direction with a related connect force;
the method comprising
providing a contact retaining wall for defining an internal groove sidewall and disposing the retaining wall at an angle from a normal to a bore centerline for causing axial compression of the spring on the piston is moved in a second direction, opposite said first direction, and a disconnect force in said second direction greater than the connect force.
